(19) United States
(12) Patent Application Publication
(10) Pub. No.: US 2007/0242643 A1
(43) Pub. Date: Oct. 18, 2007

(54) Using a wireless beacon broadcast to provide a media message

(75) Inventors: Ranveer Chandra, Kirkland, WA (US); Jitendra D. Padhye, Redmond, WA (US); Alastair Wolman, Seattle, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/404,639

(22) Filed: Apr. 14, 2006

(51) Int. Cl. H04Q 7/24

(52) U.S. Cl. 370/338

(57) ABSTRACT

A system and method for using a wireless beacon broadcast to provide a media message is disclosed. A first beacon broadcast is provided from a wireless access point, the first beacon broadcast having a first beacon component with a first portion of media. A second beacon broadcast is provided from the wireless access point, the second beacon broadcast having a second beacon component with a second portion of media. The first portion of media and the second portion of media are combinable to provide a complete media message.

### BACKGROUND

Presently, many consumers carry some type of personal electronic device during their daily routine. For example, a typical person might carry and use one or more of an assortment of mobile devices such as a mobile phone, a personal digital assistant (PDA), a laptop, a palmtop, a combination phone-PDA-palmtop device, and the like.

Prior to consumers carrying mobile devices, when an advertiser wanted to reach a consumer, the advertiser would provide a static advertisement such as a poster, billboard, magazine or newspaper advertisement, phone directory advertisement or the like in a conspicuous location. However, advertisers are always expanding their methods of reaching consumers. For example, with the placement of navigation devices in vehicles, advertisers have been very willing to provide content to the navigation provider. As a result, if a consumer is driving a car, the consumer can access the navigation device and receive a list of available resources.

In other words, if the consumer is interested in dinner, for example, the navigation device will provide a list of restaurants and their associated distances. Moreover, the navigation device will provide the consumer with different selections based on criteria such as distance, type of food, pre-programmed favorites, advertiser payments, and the like. In a similar scenario, a consumer can utilize a computer to access the Internet and search for a restaurant based on name, type, location, etc.

Thus, advertisers are aware that the consumer is becoming more dependent on the Internet and mobile device when making decisions or looking for ideas and have increased their electronic presence accordingly. However, a significant problem exists when a consumer is not in the car, does not have immediate access to the Internet, or has access to the Internet but does not know their location.

For example, if a consumer is walking in a mall or market and wants to know the list of stores or restaurants in the area, calling 411 is time consuming, and looking up information on the Internet requires the user to know his/her location and have access to an Internet accessible device with Internet connectivity available.

One solution to the problem is to provide a map that lists nearby locations of interest. However, there are two problems with this type of approach. First, the information provided in the map is typically static and does not allow the advertiser to provide any real time or near-real-time information to the consumer. For example, if the store is having a large sale, the static map will not provide this information. Thus, if a consumer does not walk past the store, the consumer will not know about the sale. Second, the consumer may be looking for restaurants and select one of the first restaurants on the map without finding or even noticing all of the available options. Thus, a restaurant higher on the static list has the opportunity to draw more consumers than a restaurant lower on the list.

Thus, what is needed is a method for providing dynamic or semi-dynamic information to a consumer in real-time or near real-time.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A system and method for using a wireless beacon broadcast to provide a media message is disclosed. A first beacon broadcast is provided from a wireless access point, the first beacon broadcast having a first beacon component with a first portion of media. A second beacon broadcast is provided from the wireless access point, the second beacon broadcast having a second beacon component with a second portion of media. The first portion of media and the second portion of media are combinable to provide a complete media message.

### DESCRIPTION OF THE DRAWINGS

The accompanying drawings, which are incorporated in and form a part of this specification, illustrate embodiments of the technology for using a wireless beacon broadcast to provide a media message and, together with the description, serve to explain principles discussed below:

FIG. 1 is a diagram of an exemplary computer system used in accordance with embodiments of the present technology for using a wireless beacon broadcast to provide a media message.

FIG. 2 is a diagram of one exemplary wireless network in accordance with an embodiment of the present system for using a wireless beacon broadcast to provide a media message.

FIG. 3 is a diagram of one exemplary embodiment of a beacon packet of the present system for using a wireless beacon broadcast to provide a media message.

FIG. 4a is a diagram of one embodiment of a beacon component utilizing the present system for using a wireless beacon broadcast to provide a media message.

FIG. 4b is a diagram of one embodiment of a second beacon component utilizing the present system for using a wireless beacon broadcast to provide a media message.

FIG. 5 is a block diagram of one exemplary access point of the present system for using a wireless beacon broadcast to provide a media message.

FIG. 6 is a flow chart of operations performed in accordance with one embodiment of the present technology for using a wireless beacon broadcast to provide a media message.

The drawings referred to in this description should be understood as not being drawn to scale except if specifically noted.

### DETAILED DESCRIPTION

Reference will now be made in detail to embodiments of the present technology for using a wireless beacon broadcast to provide a media message, examples of which are illustrated in the accompanying drawings. While the technology for using a wireless beacon broadcast to provide a media message will be described in conjunction with various embodiments, it will be understood that they are not intended to limit the present technology for using a wireless beacon broadcast to provide a media message to these embodiments. On the contrary, the presented technology for using a wireless beacon broadcast to provide a media message is intended to cover alternatives, modifications and equivalents, which may be included within the spirit and scope the various embodiments as defined by the appended claims.

Furthermore, in the following detailed description, numerous specific details are set forth in order to provide a thorough understanding of the present technology for using a wireless beacon broadcast to provide a media message. However, the present technology for using a wireless beacon broadcast to provide a media message may be practiced without these specific details. In other instances, well known methods, procedures, components, and circuits have not been described in detail as not to unnecessarily obscure aspects of the present embodiments.

Unless specifically stated otherwise as apparent from the following discussions, it is appreciated that throughout the present detailed description, discussions utilizing terms such as “receiving”, “performing”, “generating”, “displaying”, “selecting”, “scrolling”, “highlighting”, “presenting”, “testing”, “identifying”, “reporting”, “prompting”, “suppressing”, “providing”, and “refreshing” or the like, refer to the actions and processes of a computer system, or similar electronic computing device. The computer system or similar electronic computing device manipulates and transforms data represented as physical (electronic) quantities within the computer system's registers and memories into other data similarly represented as physical quantities within the computer system memories or registers or other such information storage, transmission, or display devices. The present technology for using a wireless beacon broadcast to provide a media message is also well suited to the use of other computer systems such as, for example, optical and mechanical computers. Additionally, it should be understood that in embodiments of the present technology for using a wireless beacon broadcast to provide a media message, one or more of the steps can be performed manually.

### EXAMPLE COMPUTER SYSTEM ENVIRONMENT

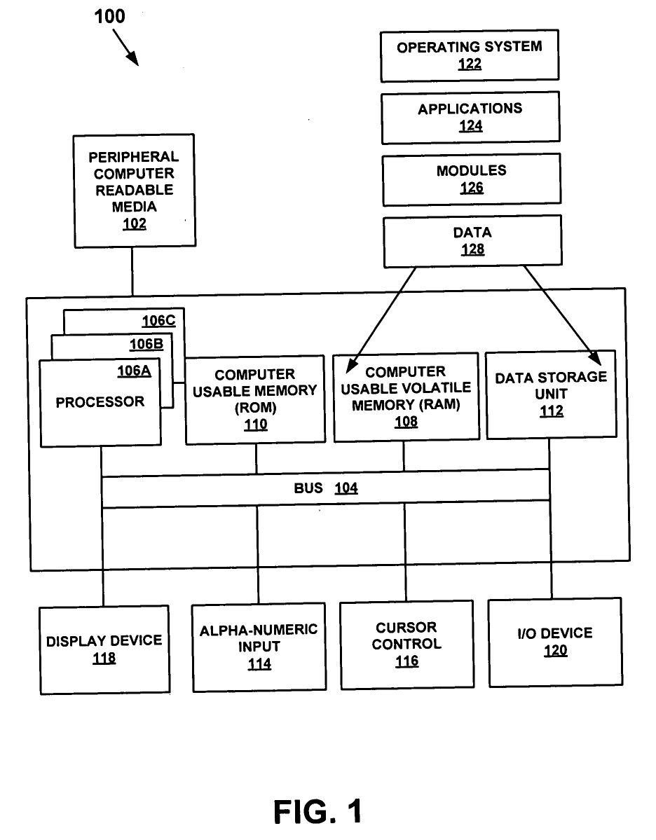

With reference now to FIG. 1, portions of the technology for using a wireless beacon broadcast to provide a media message are composed of computer-readable and computer-executable instructions that reside, for example, in computer-usable media of a computer system. That is, FIG. 1 illustrates one example of a type of computer that can be used to implement embodiments, which are discussed below, of the present technology for using a wireless beacon broadcast to provide a media message. FIG. 1 illustrates an exemplary computer system 100 used in accordance with embodiments of the present technology for using a wireless beacon broadcast to provide a media message. It is appreciated that system 100 of FIG. 1 is exemplary only and that the present technology for using a wireless beacon broadcast to provide a media message can operate on or within a number of different computer systems including general purpose networked computer systems, embedded computer systems, routers, switches, server devices, consumer devices, various intermediate devices/nodes, stand alone computer systems, and the like. As shown in FIG. 1, computer system 100 of FIG. 1 is well adapted to having peripheral computer readable media 102 such as, for example, a floppy disk, a compact disc, and the like coupled thereto.

System 100 of FIG. 1 includes an address/data bus 104 for communicating information, and a processor 106A coupled to bus 104 for processing information and instructions. As depicted in FIG. 1, system 100 is also well suited to a multi-processor environment in which a plurality of processors 106A, 106B, and 106C are present. Conversely, system 100 is also well suited to having a single processor such as, for example, processor 106A. Processors 106A, 106B, and 106C may be any of various types of microprocessors. System 100 also includes data storage features such as a computer usable volatile memory 108, e.g. random access memory (RAM), coupled to bus 104 for storing information and instructions for processors 106A, 106B, and 106C. System 100 also includes computer usable non-volatile memory 110, e.g. read only memory (ROM), coupled to bus 104 for storing static information and instructions for processors 106A, 106B, and 106C. Also present in system 100 is a data storage unit 112 (e.g., a magnetic or optical disk and disk drive) coupled to bus 104 for storing information and instructions. System 100 also includes an optional alphanumeric input device 114 including alphanumeric and function keys coupled to bus 104 for communicating information and command selections to processor 106A or processors 106A, 106B, and 106C. System 100 also includes an optional cursor control device 116 coupled to bus 104 for communicating user input information and command selections to processor 106A or processors 106A, 106B, and 106C. System 100 of the present embodiment also includes an optional display device 118 coupled to bus 104 for displaying information.

Referring still to FIG. 1, optional display device 118 of FIG. 1, may be a liquid crystal device, cathode ray tube, plasma display device or other display device suitable for creating graphic images and alphanumeric characters recognizable to a user. Optional cursor control device 116 allows the computer user to dynamically signal the movement of a visible symbol (cursor) on a display screen of display device 118. Many implementations of cursor control device 116 are known in the art including a trackball, mouse, touch pad, joystick or special keys on alpha-numeric input device 114 capable of signaling movement of a given direction or manner of displacement. Alternatively, it will be appreciated that a cursor can be directed and/or activated via input from alpha-numeric input device 114 using special keys and key sequence commands. System 100 is also well suited to having a cursor directed by other means such as, for example, voice commands. System 10o also includes an I/O device 120 for coupling system 100 with external entities. For example, in one embodiment, I/O device 120 is a modem for enabling wired or wireless communications between system 100 and an external network such as, but not limited to, the Internet. A more detailed discussion of the present technology for using a wireless beacon broadcast to provide a media message is found below.

Referring still to FIG. 1, various other components are depicted for system 100. Specifically, when present, an operating system 122, applications 124, modules 126, and data 128 are shown as typically residing in one or some combination of computer usable volatile memory 108, e.g. random access memory (RAM), and data storage unit 112. In one embodiment, the present technology for using a wireless beacon broadcast to provide a media message, for example, is stored as an application 124 or module 126 in memory locations within RAM 108 and memory areas within data storage unit 112.

### General Description of the Technology

As an overview, in one embodiment, the present technology for using a wireless beacon broadcast to provide a media message is directed towards the plethora of wireless devices presently and persistently listening to any and all receivable network beacon packets in the air. In one embodiment, customizable media messages such as text, sound, video, and the like can be delivered via concatenation of multiple beacon packets over multiple beacon broadcasts.

In another embodiment, the beacon packet can provide information to a computing device regarding a particular server address, wherein the computing device can access the server and receive and download customizable media messages based on the particular location.

In yet another embodiment, the beacon from the access point may include two or more variations. For example, a first beacon variation is broadcast with connection capabilities for the access point and a second beacon variation is broadcast with only a media message and limited or no connection information. The variety of beacons is modified such that a device using the first variation beacon to connect to the access point does not disconnect from the access point when the second variation beacon is broadcast.

Therefore, the media message dissemination scheme is more efficient than prior art techniques because it does not require clients to connect to the access point to receive the media messages.

### EXEMPLARY SYSTEM

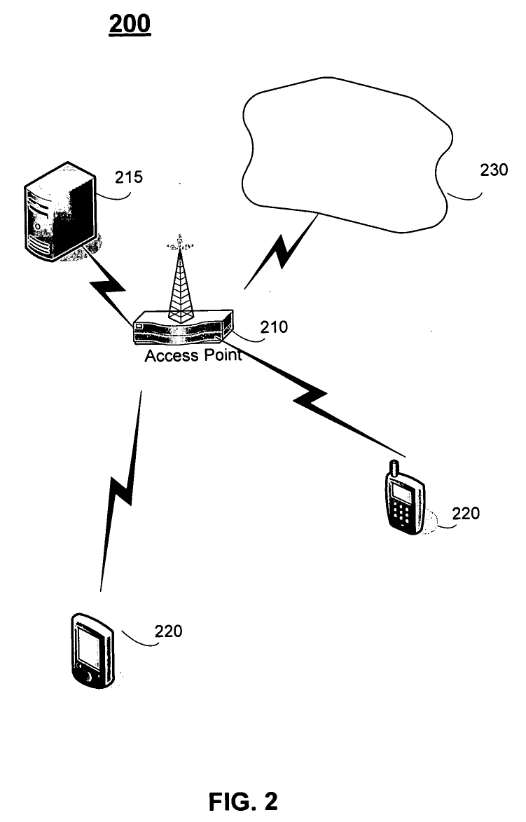

With reference now to FIG. 2, a diagram of one embodiment of the present system 200 for using a wireless beacon broadcast to provide a media message is shown. The following discussion will begin with a description of the physical structure of the present system for using a wireless beacon broadcast to provide a media message. This discussion will then be followed with a description of the operation of the present technology. With respect to the physical structure, system 200 is comprised of a computing system 215, a wireless access point 210, one or more mobile computing device(s) 220 and a network 230.

In general, computing system 215 is a computer such as system 100 of FIG. 1. Computing system 215 is used to control the beacon content of the wireless access point 210. In one embodiment, the computing system 215 is either directly connected to the access point 210 or coupled with access point 210 over the network 230.

Wireless access point 210 is used to support wireless data communications over a network 230 (e.g., the Internet). In one embodiment, the wireless access point 210 is an IEEE standard 802.11 access point However, the wireless access point 210 may operate under one or more different operational modes. The recitation of the IEEE 802.11 standard is provided herein merely for purposes of brevity and clarity. In addition to providing data frames that carry higher layer information, the wireless access point 210 also transmits beacon frames which enable mobile computing devices 220 to establish and maintain communications with the wireless access point 210 in an orderly fashion.

The mobile computing device 200 is a mobile computing device (having components such as those described in FIG. 1) capable of receiving a beacon transmission from the wireless access point and presenting any media associated therewith. For example, the media may be presented in an audio format, a text message, an image, a video, a uniform resource locator (URL), or a combination thereof. Thus, the mobile computing device 220 could be a palmtop, a laptop, a personal digital assistant (PDA), a mobile phone, or the like.

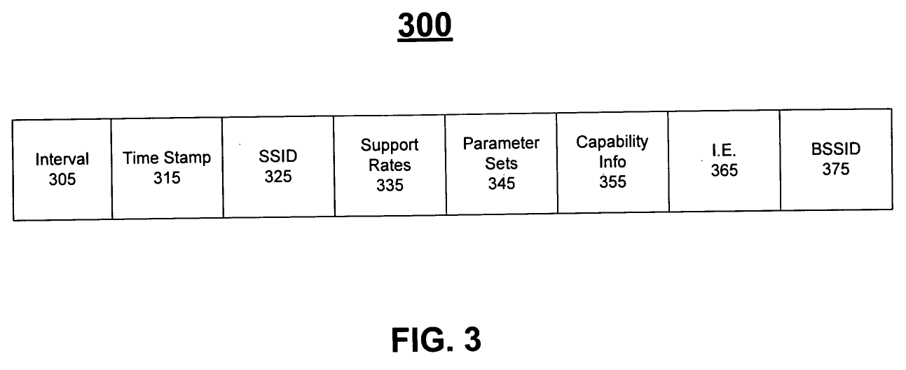

Referring now to FIG. 3, a typical beacon frame 300 is shown in accordance with one embodiment of the present technology. Although a plurality of components is shown as part of beacon frame 300, the components are exemplary. That is, the beacon frame 300 utilized herein is readily capable of providing more or fewer components including more or less content.

In one embodiment, exemplary beacon frame 300 includes an interval component 305, a timestamp component 315, a service set identifier component (SSID) 325, a support rate component 335, a parameter sets component 345, a capability information component 355, an information element (IE) 365 and a basic service set identifier (SSID) component 375.

In general, the interval component 305 provides the amount of time between beacon transmissions from the access point 210 (of FIG. 2). The timestamp 315 allows a station receiving the beacon 300 to update its clock providing well-known synchronization characteristics. The SSID 325 identifies a wireless network. Generally, access points (such as 210 of FIG. 2) include the SSID 325 in the beacon frame 300 to enable sniffing functions to identify the network and configure access based on the SSID 325.

Support rate 335 includes rate information such as 2, 5.5, 11 Mbps and the like, that are available from the access point 210. Parameter sets 345 can include signal information such as spectrum, frequency and the like. Capability information 355 includes station requirements such as privacy, security, and other requirements necessary for a user to utilize the access point. IE 365 has a maximum size of 253 bytes and can perform actions such as those described herein. That is, the support rate 335, or the like, could be an IE 365. Additionally, the IE 365 could be a customized component related to a specific network access point. BSSID 375 is the media access control (MAC) machine address of the access point (AP). This field uniquely identifies each basic service set.

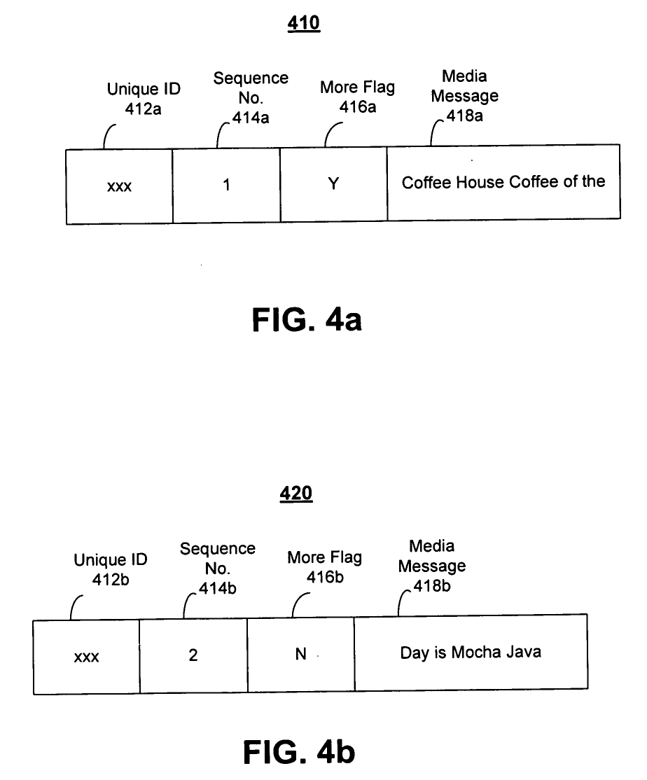

With reference now to FIGS. 4a and 4b, in one embodiment, the media messages are provided in a portion of the beacon frame over a plurality of concatenated beacon broadcasts. For example, first beacon 410 and second beacon 420 illustrate a beacon portion changing to provide a media message 418a and 418b received over a plurality of beacon broadcasts. In general, the beacon portion 410 (or 420) may be the SSID component or any other component (e.g., IE 365, capability information 355, parameter 345, etc.).

For example, in one embodiment, as described in detail herein, if the access point 210 is modified to provide no access to a network 230 and instead act only as an advertising beacon, then any or all of the components within the beacon frame 300 may be modified to provide the media message. However, in another embodiment, the access point is still a viable means for reaching the network and as such, only non-connection components (or additional components such as IE 365) are modified to provide the media message in the beacon.

In one embodiment, the component used to provide the media message is divided into four sections to allow easy reassembly of media messages that span multiple beacons. The first section is the unique identifier 412 (a and b), the second is the sequence number 414 (a and b), the third is the more flag 416 (a and b) and the fourth is the media 418 (a and b). Although four sections are described herein, more or fewer sections may be utilized. The description of the four sections herein is merely one embodiment and is provided herein for purposes of brevity and clarity.

In one embodiment, the unique identifier 412 (a and b) provides an identifier while the sequence number 414 (a and b) provides an order for the component received. For example, the device can check the sequence number to ensure that a beacon was not missed, lost, or the like. The more flag 416 provides the information as to whether the received beacon is the final beacon of the broadcasts or if more beacons with more media information are available. For example, first beacon 410 will have more flags 416a while second beacon 420 will have no more flag 416b. Therefore, when second beacon 420 is received and more flag 416b is negative and no sequence numbers 414 (a and b) are missing, the device will know that the media message is now complete. Media message 418a and 418b are the portions of media provided in each beacon component.

For example, after receiving both beacons, the device will be able to generate the message “Coffee-House coffee of the day is Mocha Java.” In so doing, any user with a device capable of receiving the wireless beacons within range of the broadcasting access point, will receive the advertisement without searching for the Coffee-House, accessing any web-site, calling any number, or performing any overt action. Therefore, because of the nature of the beacon, an advertiser can provide information to the consumer at real or near real-time with no cost to the consumer.

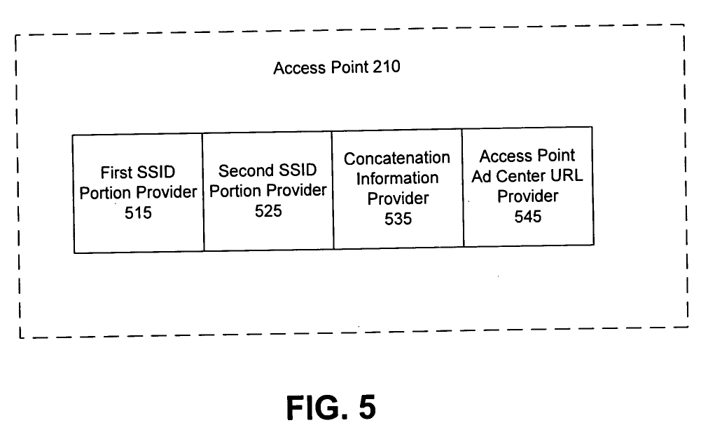

With reference now to FIG. 5, a block diagram of one exemplary access point 210 of the present system for using a wireless beacon broadcast to provide a media message. In one embodiment, access point 210 includes a first SSID portion provider 515, a second SSID portion provider 525, a concatenation information provider 535 and an access point ad center URL provider 545.

As described herein, the first SSID portion provider 515 and the second SSID portion provider 525 are configured to provide a first and second broadcast beacon SSID which are combinable to provide directions for receiving at least a portion of a media message in a user sensorial format. In one embodiment, the combination is performed with the help of the concatenation information provided by the concatenation information provider 535. The ad center URL provider 545 is configured to provide an access point ad center URL. By utilizing the ad center URL, a consumer device is able to download a complete media message over a network connection.

### Exemplary Methods of Operation

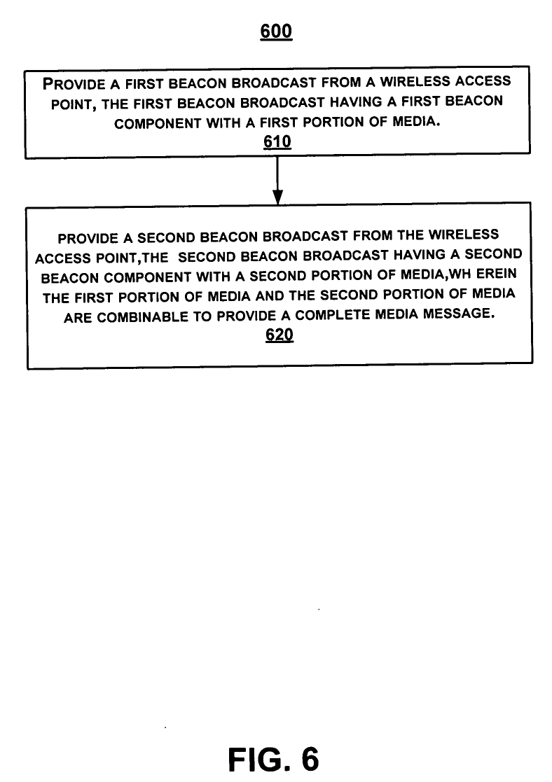

The following discussion sets forth in detail the operation of present technology for using a wireless beacon broadcast to provide a media message. With reference to FIG. 6, flow chart 600 illustrates an exemplary method used by various embodiments of the present technology for using a wireless beacon broadcast to provide a media message. Flow chart 600 includes processes that, in various embodiments, are carried out by a processor under the control of computer-readable and computer-executable instructions. The computer-readable and computer-executable instructions reside, for example, in data storage features such as computer usable volatile memory 108, computer usable non-volatile memory 110, and/or data storage unit 112 of FIG. 1. The computer-readable and computer-executable instructions are used to control or operate in conjunction with, for example, processor 106A and/or processors 106A, 106B, and 106C of FIG. 1.

Although specific details are disclosed in flow chart 600, such details are exemplary. That is, embodiments are well suited to performing various other variations than those recited in flow chart 600. It is appreciated that the steps in flow chart 600 may be performed in an order different than presented, and that not all of the steps in flow chart 600 may be performed.

Referring now to flow chart 600 of FIG. 6 a method for using a wireless beacon broadcast to provide a media message is shown in accordance with one embodiment of the present technology.

With reference now to 610 of FIG. 6 and to FIGS. 2 and 4, one embodiment provides a first beacon 410 broadcast from a wireless access point 210. Wherein, the first beacon 410 broadcast has a first beacon component 410 with a first portion of media 418. For example, the first beacon 410 broadcast of FIG. 4 includes the media message 418a.

Normally, beacon 300 is used to provide information about the access point 210 to a device such as device 220. By providing information about the access point 210 to the device 220, the device 220 is able to learn a great deal about that particular access point 210 or network 230. In so doing, the device 220 is able to rank the access point 210 based on signal strength of the beacon, capability information of the network 230 and the like.

Additionally, even when a device 220 is coupled with a network 230 via the access point 210, the device 220 will continue to periodically scan for other beacons. The scanning vigilance provides the opportunity for the device 220 to see other beacons from other access points that may be better connections, or provide a jump-off point if the present access point 210 beacon becomes too weak to maintain communication.

Therefore, the use of the beacon 300 of FIG. 3 is important to the overall operation of a wireless network. Moreover, because of the constant monitoring of beacons by computing devices, the beacon provides the ability to be received by a wireless device regardless of whether the wireless device is connected to the access point broadcasting the beacon. Embodiments described herein utilize the beacon and its reception properties to provide a new and unrecognized method for delivering wireless media messages. These media messages include text, audio, video and the like. Moreover, the media messages can be static, dynamic or real-time changing messages.

Referring still to 620 of FIG. 6 and to FIGS. 2 and 4, one embodiment provides a second beacon 420 broadcast from the wireless access point 210, the second beacon 420 broadcast having a second beacon component 420 with a second portion of media 418b, wherein the first portion of media 418a and the second portion of media 418b are combinable to provide a complete media message. In one embodiment, the media message is provided in a user sensorial format selected from the group of formats including, text, audio, and video.

For example, when the computing device 220 receives the two beacons (e.g., 410 and 420) and concatenates the media, the computing device 220 will then provide the complete media message to the user. In the present example, the media message would be “Coffee-House coffee of the day is mocha java.” Moreover, the media message may includes any number of items such as, but not limited to, stock quotes, advertisement, prices, sales, goods, store hours, location, address, phone number, specials, owners, and the like. Although, the presentation of the media is described as a message herein, the media could be provided in any type of format. For example, the media could be the company jingle, the latest commercial, or the like.

In another embodiment, the media message may be broken into two or more layers. That is, the media message may include layers that are sent at different rates or fit in different numbers of beacon broadcasts. For example, at each message 418a the most important information (e.g., name and number of the advertising entity) is provided. This would be the first layer and would ensure that the name and number (or other information) would be received by any entity receiving any beacon broadcast. A second layer having less important information (e.g. address, daily specials, etc.) would also be provided and would span a couple of beacon broadcasts (e.g., beacon 410 and 420). The second layer would be provided to a device in the area receiving a plurality of beacons.

The layer method described herein is easily expanded to provide for any number of layers. Moreover, although a two layer method is described herein, the technology does not require layers for operation. Furthermore, the first layer does not necessarily need to be the most important layer, each layer could be equally important or the second layer could be more important that the first. Thus, the layer discussion provided herein is merely one embodiment provided for purposes of brevity and clarity.

In one embodiment, not only are different layers broadcast upon different numbers of beacons, but the send rate per layer may also change. For example, the first layer beacon may be sent five times a second, while the second layer is sent three times a second, etc. Further adjustments may also be made based on the media message size, advertiser's payment-per-broadcast scenario, and the like.

In yet another embodiment, the media message may be partially available to every user but a publish-subscribe (pub-sub) option will allow consumers to define an interest level and receive ads at that level. For example, if a consumer is not a subscriber or does not wish to receive entire media messages (e.g., ads, sales, etc.) the device may only provide the media message at the first level. However, if the consumer is a subscriber and does wish to receive the entire media message, both the first and second layer, or the entire media message will be provided. In other words the pub-sub is for specifying categories of interest, not the level of detail that a user is interested in seeing.

For example, if a consumer selects to receive only the first layer information, e.g., the store name, then any other media (e.g., advertising etc.) would be missed by the consumer. However, if a second consumer was a subscriber and received the same message the consumer would see the store name as well as the advertising message.

In one embodiment, the beacon (e.g., 410 or 410) also provides concatenation information for the first SSID 410 with a first portion of media 418a and the second SSID 420 with a second portion of media 418b. Generally, the concatenation information provides directions for concatenating the first portion of the media 418a and the second portion of the media 418b into a concatenated media message.

By concatenating the media message from a plurality of beacon broadcasts, significant advantages are realized. One advantage to using the SSID field is the ability to provide a media message that is of significantly larger size that the 32 bytes provided in the normal SSID component. That is, by concatenating a plurality of beacon SSID components, the media message size limitations are increased based on the ability of the concatenation process at the client software level. Moreover, by utilizing the concatenation of components within the beacon, the access point remains viable as a gateway to the network while delivering the larger media message. Additionally, because the concatenation works at the application level, larger messages can be received by a consumer's device without requiring kernel level modification.

Yet another beacon broadcast component that can be modified to carry a portion of a concatenateable message is the BSSID 375 portion. One advantage to using the BSSID field is the ability to provide a media message that is of significantly larger size that the 6 bytes provided in the normal BSSID component. That is, by concatenating a plurality of beacon BSSID components, the media message size limitations are increased based on the ability of the concatenation process at the client software level. Moreover, by utilizing the concatenation of components within the beacon, the access point remains viable as a gateway to the network while delivering the larger media message. Additionally, because the concatenation works at the application level, larger messages can be received by a consumer's device without requiring kernel level modification.

Another beacon broadcast component that can be modified to carry a portion of a concatenateable message is the IE 365 portion. One advantage to using the IE 365 field is the ability to provide a media message that is 253 bytes in size. Moreover, by concatenating the IE 365 field a message of significantly larger size that the 253 bytes provided in the normal IE 365 component is realized. That is, by concatenating a plurality of beacon IE 365 components, the media message size limitations are increased based on the ability of the concatenation process at the client software level. Moreover, by utilizing the concatenation of components within the beacon, the access point remains viable as a gateway to the network while delivering the larger media message. Moreover, although the bandwidth is higher and there is no requirement for ISP support, kernel modification at the client may be necessary. That is, in some cases, driver change in non native WiFi cards may be necessary.

By providing the media message in a portion of the beacon packet, the media provider is able to reach consumers whether or not they are connected to a network. Additionally, by modifying the beacon, an access point 210 (of FIG. 2) can provide a beacon whether or not it actually provides access to a network 230. In other words, a device 220 will receive the beacon and process the beacon regardless of whether the access point 210 broadcasting the beacon includes network access. Because the beacon is programmable, the media is updateable and can be dynamic. For example, the media may include the number of tickets left, the daily specials, stock quotes, and the like.

One method for tracking the media message broadcast is to assign a unique basic SSID (BSSID) to the beacon broadcast. The receiver 220 will then keep track of the time and source access point 210 for each media message received. Then, an access point 210 (either the same or a different access point 210) can receive or request the information from the device 220. In one embodiment, the requesting access point 210 is a special access point 210 designated for reception only. In another embodiment, the requesting access point 210 is a regular access point 210.

By tracking the media messages received and the access points which broadcast the beacons, it is possible to track the ad frequency of a specific access point. In so doing, it is possible to build a business model that pays based on the number of media messages sent, the number received or a plurality of other receive-send scenarios. Furthermore, in one embodiment, because of the ability to provide the access point beacon broadcast as media message only, the access point can be mounted on a moving platform, such as a bus, taxi, train, etc., and provide periodic advertisements or other types of media messages. In one embodiment, the media messages can be broadcast at intervals based on location of the access point, e.g., at specific times on a specific route, timed intervals, and the like dependent on exactly what the media message contains or the advertiser chooses.

In many cases, it may be important to reduce beacon saturation and control the broadcast range of the beacon. In one embodiment, this control is achieved by modifying a broadcast data rate of the wireless access point 210. In another embodiment, the broadcast range of the beacon is controlled by modifying a broadcast power of the wireless access point 210. For example, the beacon broadcast range can be controlled by sending beacons at a higher rate and lower power.

In general, there are a plurality of methods for utilizing a wireless fidelity (WiFi) network or wireless local area network access point 210 for both a pathway to the Internet 230 and a media message provider. One embodiment provides a plurality of access points 210 for the wireless network 230, wherein at least a first access point 210 is available for accessing the wireless network 230 and wherein at least a second access point 210 is available for providing the media message to a user device 220.

Another embodiment involves spoofing more than one beacon broadcast to simulate two access points 210 when only one access point 210 is actually active. For example, a first beacon basic SSID (BSSID) is provided with the first beacon broadcast 410 and the second beacon broadcast 420, the first beacon 410 and the second beacon 420 each provide at least a portion of the media message 418a and 418b respectively. Then, a second beacon BSSID is provided with a third beacon broadcast from the same access point 210, the third beacon broadcast will provide actual connection information for the access point 210.

Switching is then performed between the first beacon BSSID and the second beacon BSSID depending on whether network 230 access is being offered (e.g., beacon three) or media messages are being broadcast (e.g., beacons 1 and 2). By associating different BSSID's with the different broadcasts from a single access point 210, a consumer utilizing the access point 210 for access to the network 230 will not be disconnected when the access point broadcasts the first BSSID because the consumer will believe a second access point 210 is sending the broadcast.

As stated herein, the media message may be placed in the SSID component 325 or any other component of the beacon package 300. How the media is placed in the beacon packet will directly relate to whether or not the access point 210 is a function network gateway. For example, if the access point 210 is media message only, then any, most or even all of the components of the beacon 300 could contain media messages. However, if the access point 210 is to act as both the media message provider and the gateway to the network 230, then the number of beacon components that can be modified is somewhat reduced.

If a beacon is broadcast from an access point 210 that will provide a gateway to the network 230, the advertiser can still utilize other portions of the beacon 300 package, such as IE 365 or other beacon subcomponents, to carry the media message. For example, the advertiser can provide vendor specific options that can leverage native WiFi to provide space up to 253 bytes in the IE 365 component instead of the available 32 bytes in the SSID 325 portion. Although in many modern WiFi drivers the capability to leverage native WiFi is standard, in some cases, the utilization of IE 365 media messages will require modification to the WiFi driver on the consumer device 220 to access the media message. Moreover, if other subcomponents of the beacon 300 are utilized to carry the media message, the message may be significantly reduced in size to adjust for the reduced bit rate of the beacon 300 subcomponent.

In one embodiment, in order to reduce spamming or attacks based on modification to the SSID 325 or other beacon 300 components, a unique identifier such as, but not limited to, a digital signature is included in the beacon for verification purposes. For example, a beacon broadcast from a first store would be validated to ensure that it was not being spoofed by a beacon broadcast from a competitor's store. In general, the signature is verifiable by consumer-side software. This software could be proprietarily provided, and is used to only display media messages or SSID's that pass the test. In addition, the verification can be helpful in distinguishing real access points 210 from access points 210 that are broadcast only.

In one embodiment, sorting software is used to place the different beacons being broadcast into different categories such as network access points, media message providers, and the like. For example, if a consumer did not maintain some type of sorting process, each and every different beacon, e.g., multiple versions of beacons from a single access point or multiple beacons broadcast from more than one access point in a single network 230, would show up in the user's list of available networks 230. This would result in a significant list of available networks which may be overwhelming to the consumer.

In another embodiment, the media message providers could be sorted based on the message. For example, a consumer would see a list of media sorted into categories such as, but not limited to, clothing, food, shelter, etc. Additionally, the software could be further adjusted to show only media selected. For example, the consumer could filter results to show food media but not shelter media, and the like. This level of software is easily extended to the pub-sub method described in detail herein and not repeated for purposes of brevity and clarity.

In yet another embodiment, instead of (or in addition to) providing the media message in the media 418 portion of the beacon 410, the media 418a and/or 418b portions may include a link to a server that has stored the media message. For example, a concatenated media message may include a server address and password for the Internet. When the consumer connects to the network 230, or if the user is connected to the network, the device will access the server on the Internet and provide the password. The server will then provide a download of any media messages associated with the password. This method advantageously allows a consumer to receive and view a media message without requiring any kernel level or application level modifications.

Thus, the media message received from the beacon can be relatively small, while the media message received from the server over the network 230 connection can be much larger. This method will provide a much faster delivery of the media while also allowing for larger media files due to the difference in speed between beacon reception and network 230 connectivity. Although a server address and password is discussed herein, the password is one of a myriad of possible methods for providing location information to a server on a network for purposes of defining location. The use of the password herein is merely for purposes of brevity and clarity.

An additional benefit of utilizing the server address/location identifier is that it allows the advertiser to track the number of times the beacon was received and utilized to receive the media message. Therefore, the advertiser would know the rate at which the broadcast was received and utilized. This would provide a method for billing as well as a method for recognizing “hot spots” and “cold spots.” Generally, a hot spot would be a beacon that generated a significant amount of traffic to the server while a cold spot would be a beacon that did not generate very much traffic. Utilizing this system, an advertiser would be able to strategically place the beacon by testing locations and locating the beacon according to best received location.

In another embodiment, the consumer device 210 would access the network 230 upon reception of the access point 210 beacon and receive the downloaded media message from the server connected to the network 230. This download would allow a device 220 not already connected to a network to receive the media message at the faster download rate. In another embodiment, the device 220 would disconnect from any network 230 it is connected to, connect via the access point 210 to the local network, download the media message and then disconnect from the local network. The device 220 could then optionally reestablish connection with the initial network 230.

Revenue Model

The following discussion includes a plurality of revenue models. Although, a number of revenue models are described herein, the actual revenue model is not limited to the following examples; the actual model may be a combination of the following examples or the like. Thus, the following examples are merely provided as a couple of the myriad of possible revenue models available for purposes of brevity and clarity.

As described herein, in one revenue model, the media message may be partially available to every user but a publish-subscribe option will allow consumers to define an interest level and receive ads at that level. For example, if a consumer is not a subscriber or does not wish to receive entire media messages (e.g., ads, sales, etc.) the device may only provide the media message at the first level. However, if the consumer is a subscriber and does wish to receive the entire media message, both the first and second layer, or the entire media message will be provided. Thus, the intent of the publish-subscribe model is to allow consumers to specify categories of interest, not just levels of interest. For example, levels of interest allow a consumer to receive 10%, 50% or 100% of all beacons, whereas categories allow a consumer to specify the kinds of ads being received irrespective of their frequency

Another revenue model includes tracking the media message broadcast. As described herein, the broadcast is tracked by assigning a unique basic SSID (BSSID) to the beacon broadcast. In another embodiment, a cryptographic key is provided in the broadcast. The receiver 220 will then keep track of the time and source access point 210 for each media message received, as well as any associated cryptographic keys or other identifying data. Then, an access point 210 (either the same or a different access point 210) can receive or request the information from the device 220. In one embodiment, the requesting access point 210 is a special access point 210 designated for reception only. In another embodiment, the requesting access point 210 is a regular access point 210.

By tracking the media messages received and the access points which broadcast the beacons, it is possible to track the ad frequency of a specific access point. In so doing, it is possible to build a business model that pays or receives payment based on the number of media messages sent, the number received or a plurality of other receive-send scenarios.

Furthermore, as described herein, because of the ability to provide the access point beacon broadcast as media message only, the access point can be mounted on a moving platform, such as a bus, taxi, train, etc., and provide periodic advertisements or other types of media messages. In another embodiment, the access point can be mounted in a public place such as a subway station, a mall, downtown, and the like. Moreover, the media messages can be broadcast at intervals based on location of the access point, e.g., at specific times on a specific route, timed intervals, payment plans and the like dependent on exactly what the media message contains, what the advertiser chooses to spend, or the like.

Another revenue model utilizes the server address/location identifier to allow the advertiser to track the number of times the media message was received. For example, the advertiser would know the rate at which a specific broadcast from a specific access point was received and utilized. This would provide a method for billing as well as a method for recognizing “hot spots” and “cold spots.” Generally, a hot spot would be a beacon that generated a significant amount of traffic to the server while a cold spot would be a beacon that did not generate very much traffic. Utilizing this system, beacons would be able to be strategically placed by testing locations and locating the beacon according to best received location. Moreover, the advertisement rate could vary based on the receive rate of the beacon. In one embodiment, the varying rate could be bid based.

In yet another revenue model, a “home” access point broadcasts advertisement beacons part time In so doing, the user could receive discounted, or even free, access to the network by allowing the access point to provide media messages in the neighborhood. Thus, a neighborhood home could become an advertising platform. In general, the rate for the advertising, or discount, could be based on neighborhood size, location, or recognition such as those methods described herein.

Thus, the present embodiments provide a method and system for using a wireless beacon broadcast to provide a media message. In addition, embodiments described herein provide a media message using a wireless beacon wherein the media message is attainable regardless of whether the receiving device has a network connection. Furthermore, embodiments described herein provide a method and system for using a wireless beacon broadcast to provide a media message that is supported by present consumer device architecture and meets WiFi standards.

Although the subject matter has been described in a language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method for using a wireless beacon broadcast to provide a media message, said computer-implemented method comprising:
providing a first beacon broadcast from a wireless access point, said first beacon broadcast having a first beacon component with a first portion of media; and
providing a second beacon broadcast from said wireless access point, said second beacon broadcast having a second beacon component with a second portion of media, wherein said first portion of media and said second portion of media are combinable to provide a complete media message.

2. The computer-implemented method of claim 1 further comprising:
providing concatenation information for said first beacon component with a first portion of media and said second beacon component with a second portion of media, said concatenation information providing directions for concatenating said first portion of said media and said second portion of said media into a concatenated media message.

3. The computer-implemented method of claim 1 further comprising:
utilizing a first service set identifier (SSID) as said first beacon component with a first portion of media;
utilizing a second SSID as said second beacon component with a second portion of media; and
providing said first SSID and said second SSID in a format comprising a unique identifier, a sequence number, a more flag and a portion of said media.

4. The computer-implemented method of claim 1 further comprising:
utilizing a first basic service set identifier (BSSID) as said first beacon component with a first portion of media;
utilizing a second BSSID as said second beacon component with a second portion of media; and
providing said first BSSID and said second BSSID in a format comprising a unique identifier, a sequence number, a more flag and a portion of said media.

5. The computer-implemented method of claim 1 further comprising:
utilizing a first information element (IE) as said first beacon component with a first portion of media;
utilizing a second IE as said second beacon component with a second portion of media; and
providing said first IE and said second IE in a format comprising a unique identifier, a sequence number, a more flag and a portion of said media.

6. The computer-implemented method of claim 1 wherein said media message is provided in a user sensorial format selected from the group of formats including, text, audio, and video.

7. The computer-implemented method of claim 1 further comprising:
providing a first beacon basic service set identifier (BSSID) with said first beacon broadcast and said second beacon broadcast, said first beacon and said second beacon providing at least a portion of said media message;
providing a second beacon BSSID with a third beacon broadcast from said access point, said third beacon providing connection information to said access point; and
switching between said first beacon BSSID and said second beacon BSSID such that a consumer utilizing said access point is not disconnected when said access point broadcasts said first BSSID.

8. The computer-implemented method of claim 1 wherein said method comprises a revenue model selected from the group of revenue models consisting of: a publish-subscribe model, a unique BSSID tracker, a home access point model, and a varying receive rate model.

9. A system for using a service set identifier (SSID) portion of a wireless network beacon to provide a media message, said system comprising:
a wireless access point;
a first SSID portion provider configured to provide a first beacon broadcast from said wireless access point; and
a second SSID portion provider configured to provide a second beacon broadcast from said wireless access point, wherein said first SSID and said second SSID are combinable to provide directions for receiving at least a portion of a media message in a user sensorial format.

10. The system of claim 9 further comprising:
a first layer SSID portion provider configured to provide a first layer SSID portion of said media message, said first layer SSID portion residing in a single beacon; and
a second layer SSID portion provider configured to provide a second layer SSID portion of said media message, said second layer SSID portion dispersed across a plurality of beacons.

11. The system of claim 9 further comprising:
a concatenation information provider configured to provide concatenation information for combining a plurality of SSID portions of said media message over a plurality of beacons to provide a complete said media message in a user sensorial format.

12. The system of claim 9 further comprising:
an access point ad center URL provider configured to provide an access point ad center URL for allowing a consumer device to download a complete said media message over a network connection, wherein said complete media message download is based on said ad center URL provided by said access point.

13. Instructions on a computer-usable medium wherein the instructions when executed cause a computer system to perform a method for concatenating a service set identifier (SSID) portion of at least two beacons broadcast from an access point of a wireless network to provide a media message, said computer-implemented method comprising:
broadcasting a first beacon having a first SSID with a first portion of media;
broadcasting a second beacon having a second SSID with a second portion of media, wherein said first portion of media and said second portion of media are distinct; and
providing concatenation information related to said first SSID portion and said second SSID portion, said concatenation information providing directions for concatenating said first portion of media and said second portion of media into a concatenated media message.

14. The instructions of claim 13 wherein said media message is provided in a user sensorial format selected from the group of formats including, text, audio, and video.

15. The instructions of claim 13 further comprising:
broadcasting said first SSID and said second SSID in a format comprising a unique identifier, a sequence number, a more flag and said portion of media.

16. The instructions of claim 13 further comprising:
controlling a broadcast range of said first beacon and said second beacon by modifying a broadcast data rate of said wireless access point.

17. The instructions of claim 13 further comprising:
controlling a broadcast range of said first beacon and said second beacon by modifying a broadcast power of said wireless access point.

18. The instructions of claim 13 further comprising:
broadcasting said first beacon and said second beacon from an access point of said wireless network.

19. The instructions of claim 18 further comprising:
broadcasting a first beacon basic SSID (BSSID) with said first beacon and said second beacon from said access point, said first beacon and said second beacon providing at least a portion of said media message;
broadcasting a second beacon BSSID with a third beacon from said access point, said third beacon providing connection information to said access point; and
switching between said first beacon BSSID and said second beacon BSSID such that a consumer utilizing said access point is not disconnected when said access point broadcasts said first BSSID.

20. The instructions of claim 13 further comprising:
providing a plurality of access points for said wireless network, wherein at least a first access point provides access to said wireless network and wherein at least a second access point provides said media message.
